(19) United States
(12) Patent Application Publication
(10) Pub. No.: US 2007/0293149 A1
(43) Pub. Date: Dec. 20, 2007

(54) Portable handheld satellite phone conversion module

(76) Inventor: Roy Wubker, Palm Beach Gardens, FL (US)

Correspondence Address: MCHALE & SLAVIN, P.A., 2855 PGA BLVD, PALM BEACH GARDENS, FL, 33410, US

(21) Appl. No.: 11/454,585

(22) Filed: Jun. 16, 2006

(51) Int. Cl. H04B 7/19

(52) U.S. Cl. 455/13.2

(57) ABSTRACT

A mobile communication device for communication and data collection and transfer utilizing a satellite phone system including a module which replaces the battery of a satellite phone and includes an embedded micro-processor, a camera, a GPS unit, a mass storage device, a display screen and communication ports. The module is designed to transmit and receive data and images without the use of a general purpose computer, personal digital assistant or the like.

### FIELD OF THE INVENTION

The invention generally relates generally to a satellite communication system. In particular, toward an integrated yet removable module for and method of modifying a commercially available portable handheld satellite phone to provide connectivity between the satellite phone system and data recording devices with near real-time data transfer capability to users via a satellite phone system without the use of a general purpose computer, personal digital assistant (PDA) or the like, while still permitting normal voice operation and handheld functionality.

### BACKGROUND OF THE INVENTION

A satellite phone is a device that transmits and receives messages via earth orbiting satellites. These satellite phones use either satellites in geostationary orbit, such as the civilian system INMARSAT®, or non-geosynchronous Low Earth Orbit (LEO) satellites for communication. Two currently deployed commercial LEO satellite systems are IRIDIUM® and GLOBALSTAR®. LEO satellites orbit the earth at low altitudes. The low altitudes decreases the power required to effectively transmit a signal between a particular satellite and a satellite phone user on or near the earth. This decreased power requirement associated with LEO satellite systems has, in part, resulted in commercially available portable handheld satellite phones. Both systems provide global, or near-global, service coverage at all times.

When a call is made with a portable handheld satellite phone, the call signal is transmitted from the satellite phone to a designated satellite operating within a particular service provider's satellite communication system. The signal is then transmitted to a particular service provider's designated terrestrial ground station (also referred to as a gateway), to one of many other satellites in the system until the signal can reach a particular system designated gateway or directly to another satellite phone depending on the system and service provider. The gateways are interconnected to public, private or government switched networks, from where the signal is delivered to a terrestrial or airborne phone on the network or sent back via the satellite system to another satellite phone. This system of communication is often commonly referred to as “SATCOM”.

Satellite phones use orbiting satellites and are independent of terrestrial infrastructure such as cellular phone towers for communication. These satellite phones are often used in remote areas, disaster areas and middle of the oceans of the world, where terrestrial infrastructure does not exist.

Furthermore, portable handheld satellite phones generally operate on battery power, so there is limited independence from terrestrial power grids or generators between battery charging intervals. Thus, one will have uninterrupted global communication even in the event of total devastation like that during war, after natural disasters or terrorist events, and the like, when all other forms of communication could be disrupted for weeks or indefinitely. Satellite phones are ideally suited for maritime, aviation, government/military, emergency/humanitarian services, mining, forestry, petroleum, etc. applications.

Commercially available portable handheld satellite phones typically include a handset-specific data connection port or cable sold as optional add-on equipment for connection to peripheral equipment, such as, a computer, PC-104, personal digital assistant (PDA), or other externally connected processor that enables the satellite phone to function like a digital modem to transmit data to the end user or receive data via the satellite system. However, this requires the user to transport additional equipment, cables, etc. in addition to the portable handheld satellite phone to accomplish data transmission from areas that may be very remote or dangerous.

Until now commercially available portable handheld satellite phone have been lacking advanced features, such as cameras, GPS, and fully integrated data ports that customers have come to expect with terrestrial phones (e.g., cellular).

What has been heretofore lacking in the art is an integrated yet removable, conformal module capable of removably interfacing with a commercially available portable handheld satellite phone to provide a combined portable handheld device capable of GPS, multimedia features and near real-time direct data transfer via an existing satellite phone system without the need for connection to a general purpose computer, PDA, or other externally connected processor device and its associated operating system.

### DESCRIPTION OF THE PRIOR ART

One example of a portable, handheld PDA device with embedded commercial Global Positioning System (GPS) and IRIDIUM® SATCOM board called “Talon Lite” is used by the U.S. Government based on Commercial Off-The Shelf (COTS) IRIDIUM® satellite communication capability and developed originally for military “blue force” tracking. Unlike the instant invention which uses direct modem-to-modem connection for near real-time data transfer, the device of “Talon Lite” uses Short Burst Data (SBD) protocol for data transmission. That is, the data received via satellite from the “Talon Lite” is organized into a packet at one of the two terrestrial gateways supporting the IRIDIUM@ system and supplied to the Internet via e-mail having a maximum 1960 bytes per packet with a delivery latency of about 5 to 20 seconds per packet. This SBD protocol necessitates that data files larger than 1960 bytes be broken into packets no larger than the defined size before it is fed into the modem, tracked, sorted and reassembled by software installed on the end receiving side that must be connected to the Internet to receive the multiple e-mail packets. The “Talon Lite” does not currently send data packets larger than 1960 bytes per message in its embodiment as a “blue force” tracking device, however, if larger files like an image were attempted, the process of multiple packets, multiple e-mails and its associated latency effect on data transfer would ensue. “Talon Lite” is also a completely repackaged handheld unit comprised of selected internal parts from an original commercially available satellite phone instead of an integrated yet removable conversion module for commercially available portable handheld satellite phones.

### SUMMARY OF THE INVENTION

The instant invention is related to a system for data transfer using a satellite phone system. The system includes a portable handheld satellite phone in electronic communication with an integrated yet removable conformal embedded system module and power supply that maintains the handheld and normal voice communication functionality of the satellite phone. The instant invention eliminates the need for a general-purpose computer, PDA, or other externally connected processor device to be connected to the satellite phone to collect, transmit or receive data. The instant invention utilizes an embedded system that uses micro controllers to permit direct sensor data output-to-modem connection for near real-time continuous data transfer of sensor data, GPS, images and other large files for as long as a SATCOM link is established with an end user receiving the data via a modem connected to a general-purpose computer, PDA, or other processor device, or another satellite phone using the module of the instant invention.

Embedded systems are known in the art as a specialized computer systems which are dedicated to perform specific pre-defined tasks, unlike a general-purpose computer, PC-104 based processor, or the like, which uses operating system software and device drivers to accomplish multiple tasks from a central processing unit (CPU). Programs on embedded systems often run with limited hardware/software resources. A personal digital assistant (PDA) is a type of embedded system, but its original embodiment was as a personal organizer that usually includes a clock, date book, address book, task list, memo pad, and calculator. PDA's in recent years have become much more versatile in that now they sometimes simulate the user operating environment and capabilities of a personal computer. Accordingly, the PDA has become a sort of hybrid departure from the original definition of an embedded system offering too much unnecessary capability and embedded software than is required to operate the instant invention. Embedded systems, in their basic form, use micro controllers to directly interface with components such as a GPS receiver, digital camera, mass storage device, or the like. This allows the embedded system to be intentionally simplified in design to lower costs, lower power consumption (about 1/10 the current draw of vernacular PC-104 technology), and increased efficiency and reliability as compared to general-purpose computers accomplishing the same task, because an embedded system is specifically designed to accomplish only the limited specific tasks it is designed to do. These embedded systems are capable of operating devices attached to the embedded systems by device interfaces (e.g. RCA, USB, RS-232, transistor-transistor logic (TTL), wireless and the like). An example of an embedded system currently used is embodied in a device that sends digital images directly from a digital camera to a printer without the use of a general-purpose computer, PDA, or the like. Another example is a camera enabled cellular phone that can capture a digital image, store the image, and transfer the image using the cellular phone as a digital modem, all without the use of a general-purpose computer, PDA, or other externally connected processor device.

Accordingly, it is an objective of the instant invention to provide an integrated yet removable conformal attachment module constructed and arranged to replace the primary battery in the portable handheld satellite phone and be capable of operating the satellite phone, collecting, organizing, storing, and supplying data between the data gathering device or devices and the portable handheld satellite phone without the use of a general-purpose computer, PDA, or other externally connected processor unit.

It is further the objective of the instant invention to provide a high power capacity rechargeable battery having at least 4800(mAh) replacing the existing primary battery in the portable handheld satellite phone for longer operational periods of data or voice communication between recharging.

It is yet another objective of the instant invention to teach a module encased in a conformal compact housing constructed and arranged to removably attach to the portable handheld satellite phone to minimize the impact on the handheld functionality of the satellite phone while maintaining normal voice communication operation.

It is still further the objective of the invention to teach a system wherein encryption of data being transmitted from by the module of the instant invention or received through the portable handheld satellite phone is possible.

Yet another objective of the invention is to teach a system which may include a removable memory storage device that can send stored images and data, on user demand or automatically, from the module of the instant invention connected to a portable handheld satellite phone to another portable handheld satellite phone with a module of the instant invention installed, or to any general-purpose computer, PDA, or the like, connected to a modem, which may or may not be another satellite telephone.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a front perspective view of a commercially available portable handheld satellite phone;

FIG. 2 is an exploded view of the module of the instant invention ready to be attached to a typical portable handheld satellite phone;

FIG. 3 is a front perspective of the module of the instant invention attached to a typical commercially available portable handheld satellite phone; and

FIG. 4 is a block diagram of the modified satellite phone in accordance with the teachings of the present instant invention.

### DETAILED DESCRIPTION OF THE INVENTION

Detailed embodiments of the instant invention are disclosed herein, however, it is to be understood that the disclosed embodiments are merely exemplary of the instant invention, which may be embodied in various forms. Therefore, specific functional and structural details disclosed herein are not to be interpreted as limiting, but merely as a basis for the claims and as a representation basis for teaching one skilled in the art to variously employ the present instant invention in virtually and appropriately detailed structure.

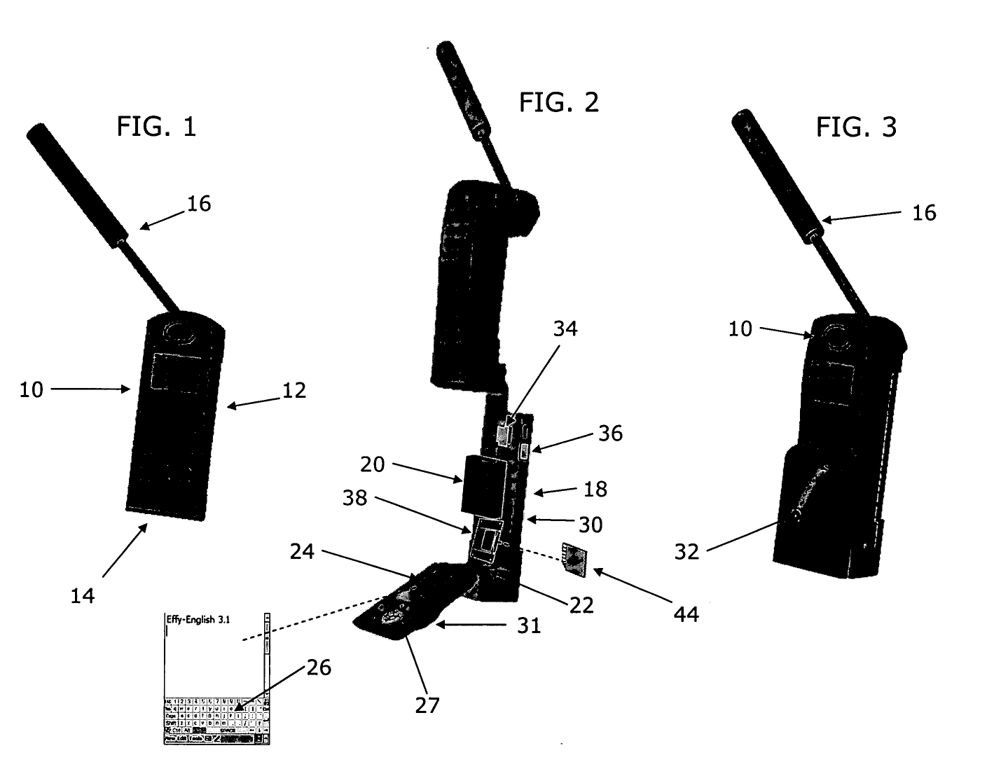

FIG. 1 illustrates a prior art commercial-off-the-shelf (COTS) IRIDIUM® system MOTOROLA® 9505 model portable handheld satellite phone 10 with its standard antenna 16 in the extended position. The handset 10 includes a removable battery 12 (not shown) and a handset specific data connection port 14. The data connection port provides an interface for a general-purpose computer, PDA, or the like, (not shown), to transmit and receive data using the satellite phone as a digital modem. It is noted that any other portable COTS satellite phones capable of providing voice and data communications to a satellite system could be used without departing from the scope of the instant invention.

As shown in FIG. 2 the module 18 of the instant invention is constructed and arranged to replace the existing or primary battery 12 and the rear cover on the COTS portable handheld satellite phone with a higher capacity (mAh) replacement battery 20, preferably a rechargeable high density Lithium Ion battery having at least 4800 mAh power reserve and which removably plugs into the existing COTS portable handheld satellite phone 10 utilizing the existing battery connections and data connection port 14 to establish electronic communication with the COTS satellite phone. The module of the instant invention is provided with connections 22 which are compatible with the data connection port 14 on the satellite phone. These connections 22 are used to transmit data, etc., from the module of the instant invention through the satellite phone connected to the satellite system. Data and other information received by the satellite phone is transmitted to the module of the instant invention via data connection port 14 and module connections 22.

The module of the instant invention is also provided with an embedded system consisting of micro controllers 30 that can be connected to external devices and in turn the embedded system communicates with the existing prior art portable handheld satellite phone. The connection for the external devices to the module of the instant invention is via port 36 utilizing digital bus standards such as Universal Serial Buss (USB), RS-232, TTL or wireless connection. An example of a suitable microcontroller (MCU) that could be used in the module of the instant invention embedded system is an ATMEL® ATmega 169 chip.

The instant invention module may also include a unit 31 which may pivot from a stowed position proximate to the outer housing of the portable handheld satellite telephone as shown in FIG. 3, to a deployed position, as shown in FIG. 2. This unit includes a display screen 24, at least one user input (touch screen, keypad, keyboard, or the like) 26 and embedded digital camera 32. The camera can function to capture images or video for transmission elsewhere through the portable handheld satellite phone or storage on the module of the instant invention. One example of the display screen is a liquid crystal display (LCD) screen. Another non-limiting example of a display screen is a touch screen such as the C0G-C128128 touch screen and the COG-T177MLH-01 touch controller from VARITRONIX®. In addition, the user could utilize a standardized virtual keyboard or keypad on the display screen 26 and/or a 5-way push button unit 27. The user enters data, commands or reviews data via virtual buttons displayed on the screen and/or the 5-way push button unit.

The module of the instant invention when connected to a portable handheld satellite phone can also have external devices such as sensors (not shown) connected to it via its available data ports 36. These sensors can include but are not limited to seismic, chemical, radiation, acoustic, broadcast, magnetic, biological, other cameras including Night Vision (NV) and infra red (IR), etc., in addition to the embedded camera integral to the module of the instant invention. These sensors can be controlled through specific software residing on the module of the instant invention to monitor over a specific time interval or respond to a specific event by activating the portable handheld satellite telephone to make a data call automatically to a monitoring station. For example a specific radio frequency can be monitored to see if and when a transmission occurs. When a transmission is detected the satellite phone will transmit a message and/or contact a specific individual. In this manner, the portable handheld satellite phone 10 and the module of the instant invention 18 attached thereto can be placed in the field and left unattended in a low power consumption or sleep mode to collect data from sensors until a user specified time interval or sensor detection event occurs and initiates a power-up of the portable handheld satellite phone to transmit a data. Pictures can be taken from the embedded camera in the module of the instant invention to capture a sensor detection event and/or to act as a secondary control verification of the unit's position in addition to the embedded Global Positioning System (GPS) unit. A user monitoring the sensors connected to the module of the instant invention can change sensors settings, time intervals, hand-off to another user dial-up number, etc., remotely at any time via SATCOM while a data call is established. For example if a digital camera is connected to module of the instant invention as an external device, the user can access the memory residing on the digital camera through the instant invention and download the images captured by the digital camera or change camera settings.

Another feature of the instant invention is the ability to automatically transmit data only after the instant invention has reached a specific location. For example, data can be acquired in one location and the transmission of the data will only occur after the instant invention has been relocated to another location by utilizing the GPS unit of the module of the instant invention. This may occur onboard a ship when it reaches a specific location.

In addition to the sensors, the instant invention is capable of operating any peripheral device which can be operated by input commands received from microprocessors. Examples of these are, but not limited to, control valves in fluid supply lines, electric motors, compressors, refrigeration units, surveillance equipment, transmitters, receivers, etc.

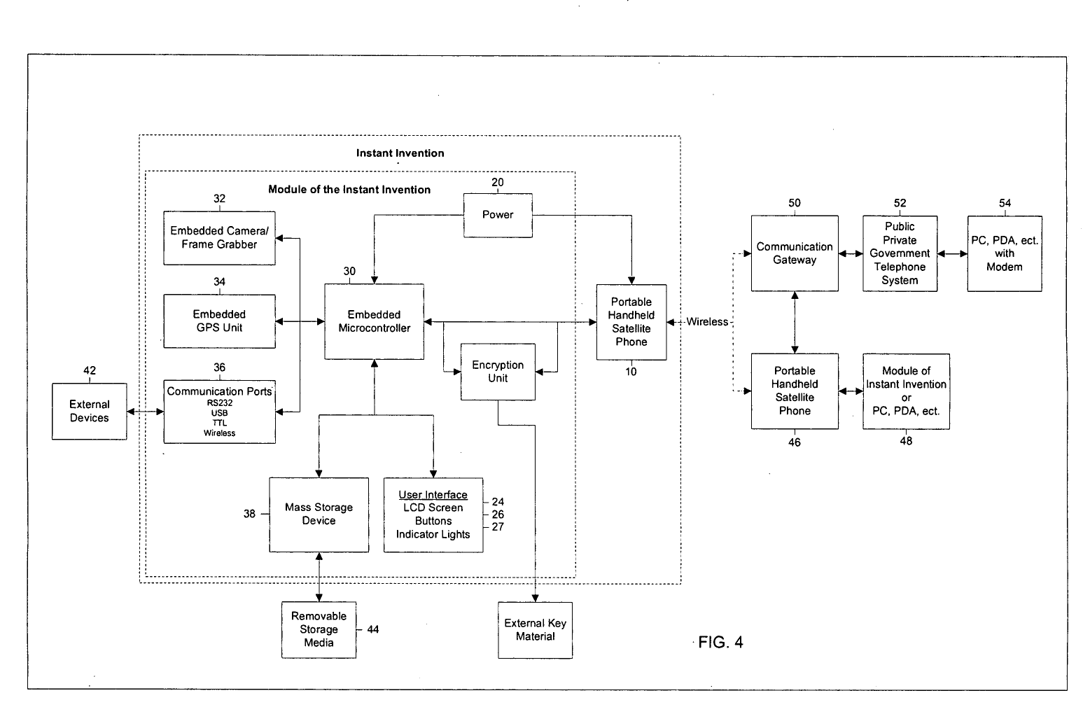

FIG. 4 is a block diagram showing the functional components housed inside the removable module of the instant invention and portable handheld satellite phone. The removable module of the instant invention includes an embedded micro controller (MCU) 30 that is connected to an embedded camera/frame grabber 32, an embedded GPS unit 34, communication ports 36, a mass storage device 38, and at least one user interface means 24, 26, 27. The mass storage device 38 is connected to the embedded micro controller 30. This mass storage device 38 utilizes removable storage media 44 to store images from the embedded digital camera 32, GPS data from the embedded GPS unit 34, or other data from sensors, other cameras, and the like, connected as external devices 42 on the removable storage media 44. Some non-limiting examples of removable storage media include memory cards such as Secure Digital (SD), Multi Media Card (MMC) and CompactFlash®. An embedded Global Position System (GPS) unit 34 can provide the microcontroller with the location of the portable handheld satellite phone in terms of longitude/latitude/altitude coordinates within the accuracy of the GPS system as well as date and time information. The mass storage device 38 can be programmed to store the information from the GPS unit 34 and data sent and received by the embedded microcontroller (MCU) 30 on the storage media 44. From stored GPS information or sent continuously near real-time via SATCOM, velocity of movement and mapping of position thereof of the instant invention can be performed by a user receiving the information via SATCOM connected to a general-purpose computer, PDA, or the like with appropriate software. The user interface can be used to access the information stored on the mass storage device 38 or it can be accessed remotely by another user via SATCOM. The user can also access information stored on external devices 42 such as sensors, other cameras, and the like, connected to the module of the instant invention from the user interface 24, 26, 27 or it can be accessed remotely by another user via SATCOM. In this way, a user accessing the unit remotely via SATCOM is able to “see through” the instant invention directly to the sensor device for near real-time reporting of data and which may also have its own integrated mass storage device. The embedded GPS unit 34 connected to the embedded microcontroller (MCU) 30 will receive signals from the GPS satellites and inform the embedded microcontroller as to the position of the instant invention and the current date/time.

The IRIDUM® system MOTOROLA® 9505 portable handheld satellite phone and potentially its follow-on versions thereof is approved by the United States National Security Agency (NSA) for use as a secure communication device for transmission of U.S. Government classified information when coupled with a non-limiting specially designed communication security (COMSEC) module with necessary key material, U.S. Government secure subscriber identity module (SIM) card for access through the designated U.S. Government gateway, and a satellite phone handset seal. The instant invention designed to integrate with the IRIDIUM® system, and potentially other applicable future NSA approved SATCOM systems, can incorporate the necessary COMSEC equipment to ensure secure transmission and receipt of data and voice communications of U.S. Government classified information in accordance with NSA guidelines and NSA approval.

The portable handheld satellite phone 10 of the instant invention is in wireless communication with other satellite phones 46, which in turn may be provided with the module of the instant invention or connected to a general-purpose computer, PDA, and the like. If communication is between at least two (2) instant inventions, data and images can be shared directly between the instant inventions in near real-time and displayed on each respective instant invention display screen 24, and stored if desired, without the use of a general-purpose computer, PDA, or the like. Also, the portable handheld satellite phone of the instant invention may be wirelessly connected to a communications gateway 50 which in turn is connected to a public, private or government telephone system 52. A general-purpose computer, PDA, or the like connected to a modem 54 may be connected to the public, private or government telephone system for communication with the instant invention.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures include herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which encompassed within the spirit of the invention and are defined by the scope of the appended claims. Although the invention has been described in connection with the preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A mobile communication device for communication and data transfer using a satellite telephone system, said device comprising:
a satellite communication phone, mounted in a portable housing of a size to be handheld by a person, including a primary battery;
a module constructed and arranged to replace said primary battery of said satellite communication phone;
said module including at least one embedded controller, said embedded controller constructed and arranged to organize and streamline data acquired by at least one peripheral device for transfer to said phone whereby said phone transmits said data or voice communication wirelessly to another satellite communication phone;
said module including a replacement battery for supplying power to said module and said satellite communication phone.

2. The mobile communication device as set forth in claim 1, wherein said module is constructed and arranged as an integrated yet removable conformal attachment unit on said satellite communication phone.

3. The mobile communication device as set forth in claim 1, wherein said module includes a data connection port constructed and arranged for connection to a data connection port on said satellite communication phone enabling data transmission between said module and said satellite communication phone.

4. The mobile communication device as set forth in claim 1, wherein said module includes a camera.

5. The mobile communication device as set forth in claim 4, wherein said camera is a digital camera integral with said module.

6. The mobile communication device as set forth in claim 1, wherein said module further includes a global positioning system device constructed and arranged to determine the location of said satellite communication phone and transmit said location to said another satellite communication phone.

7. The mobile communication device as set forth in claim 6, wherein said global positioning device is integral with said module.

8. The mobile communication device as set forth in claim 1, wherein said module further includes at least one display screen.

9. The mobile communications device as set forth in claim 8, wherein said display screen is a Liquid Crystal Display screen.

10. The mobile communications device as set forth in claim 8, wherein said display screen comprises a touch screen for input of commands, data or data review.

11. The mobile communications device of claim 1, wherein a keyboard is provided on said module for data input, command input or data review.

12. The mobile communications device of claim 1, wherein a 5-way push button is provided on said module for data input, command input or data review.

13. The mobile communication device as set forth in claim 1, further including at least one data access port on said module, said data access port comprising at least one port selected from the group of a RS-232 port, a Universal Serial Bus (USB) port, a TTL port or a wireless port.

14. The mobile communication device as set forth in claim 1, wherein said module further includes a mass storage device with removable memory media for storing data acquired by said at least one peripheral device and other data.

15. The mobile communication device as set forth in claim 4, further including means for selectively activating said camera for capturing images in real time over a set period of time.

16. The mobile communication device as set forth in claim 6, further including means for selectively activating said global positioning unit.

17. The mobile communication device as set forth in claim 1, further including means for selectively activating said at least one peripheral device.

18. The mobile communication device as set forth in claim 17, further including means for storing the captured images on a removable memory storage device.

19. The mobile communication device as set forth in claim 16, further including means for storing the global positioning data on a removable memory storage device.

20. The mobile communication device as set forth in claim 17, further including means for storing the data from said peripheral devices on a removable memory storage device.

21. The mobile communication device as set forth in claim 1, further including means to place the communication device in a power down mode and means to reactivate said communication device when a sensor detects or measures a physical property or event or at a certain time or location interval.

22. The mobile communication device as set forth in claim 17, further including means for controlling said at least one peripheral device.

23. The mobile communication device as set forth in claim 1, wherein said module further includes a communication security encryption unit, satellite phone seal, key material, and a secure subscriber identity module (SIM) card constructed to transmit and receive classified or unclassified voice and data.

24. An integrated yet removable module for a portable satellite phone including a data connection port, said module comprising:
at least one embedded controller, said embedded controller constructed and arranged to capture images, GPS data and organize and streamline data acquired by at least one peripheral device for transfer to a satellite phone;
at least one data access port for connection to said at least one peripheral device;
a battery for supplying power to a portable satellite phone and said module; and
means to transmit said data or voice communication wirelessly via a particular satellite system to another satellite phone.

25. The removable module as set forth in claim 24, wherein said module further includes a data connection port constructed and arranged for connection to a data connection port on a satellite phone.

26. The removable module as set forth in claim 24, wherein said module further includes a camera.

27. The removable module as set forth in claim 24, wherein said camera is a digital camera integral with said module.

28. The removable module as set forth in claim 24, wherein said battery has a capacity of at least 4800 mAh.

29. The removable module set forth in claim 28, wherein said high density battery is a Lithium Ion battery.

30. The removable module as set forth in claim 24, further including a global positioning system device constructed and arranged to determine the location of said module and transmit said location wirelessly via a particular satellite system to another satellite phone.

31. The removable module as set forth in claim 24, wherein said module further includes at least one display screen.

32. The removable module as set forth in claim 31, wherein said at least one display screen is a Liquid Crystal Display screen.

33. The removable module as set forth in claim 31, wherein said at least one display screen comprises a touch screen for input of commands, data or data review.

34. The removable module as set forth in claim 24, wherein a keyboard or 5-way push button is provided on said module for input of commands, data or data review.

35. The removable module as set forth in claim 24, further including at least one data communication port on said module, said data access port comprising at least one port selected from the group of a RS-232 port, USB port, TTL port or wireless port.

36. The removable module as set forth in claim 26, wherein said module further includes an integral mass storage device with removable memory media for storing images, GPS information, and other data.

37. The removable module as set forth in claim 24, wherein said module further includes a communication security encryption unit, satellite phone seal, key material, and a secure subscriber identity module (SIM) card constructed to transmit and receive classified or unclassified voice and data.

38. The removable module as set forth in claim 26, further including means for selectively activating said camera, said GPS unit, or external devices such as sensors electronically connected to said data ports for capturing images and data in real time over a set period of time.

39. The removable module as set forth in claim 38, further including means for storing the captured images and data from said external devices on a mass storage device with a removable storage media.

40. The removable module as set forth in claim 38, further including means for controlling said camera, said GPS unit or said external devices.

41. The removable module as set forth in claim 24, further including means to place said removable module in a power down mode and a sensor or time interval or location based means to reactivate the removable module when said sensor detects or measures a physical property or event or said time interval or location position occurs.

42. A satellite communication device for communication, data storage and data transfer using a satellite telephone system, said device comprising:
a portable digital satellite phone, mounted in a portable housing of a size to be handheld by a person, including a primary battery;
a module constructed and arranged to replace a primary battery of said satellite communication device which supplies power to said module and said portable satellite phone;
said module including a replacement battery having at least 4800 mAh power reserve for supplying power to said module and said satellite communication phone;
said module constructed and arranged in such a manner to be an integral yet removable conformal attachment unit preserving handheld portability and communication functionality of said portable digital satellite phone;
said module further including a data connection port constructed and arranged for connection to a data connection port on said portable digital satellite phone enabling data transmission between said module and said portable digital satellite phone;
said module further including a digital camera integral with said module;
said module further including a global positioning system unit constructed and arranged to determine the location of said portable digital satellite phone;
said module including at least one embedded controller, said embedded controller constructed and arranged to capture images, GPS information, and organize and streamline data acquired by at least one peripheral device for storage or transfer to said portable satellite phone whereby said portable digital satellite phone transmits said data or voice communication wirelessly via a particular satellite system to another satellite communication device or receives voice and data from another satellite communication device in near real time;
said module further including a display screen, said display screen comprising a touch screen for input of commands, data or data review;
said module further including a keyboard or 5-way push button for input of data, commands, and data review;
said module further including a communication security encryption unit, satellite phone seal, key material, and a secure subscriber identity module (SIM) card to transmit and receive classified or unclassified voice and data;
said module further including at least one data access port on said module, said data access port comprising at least one port selected from the group of a RS-232 port, a Universal Serial Buss (USB) port, a TTL port or a wireless port;
said module further including an integral mass storage device with removable memory media for storing images, GPS information, and other data;
means for selectively activating said digital camera, GPS unit, and peripheral devices such as sensors connected to said data ports;
said module further including means to place the removable module and portable digital satellite phone in a power down mode and a sensor or time interval based means to reactivate the removable module and portable digital satellite phone as necessary when said sensor detects or measures a physical property or event or when said time interval event occurs.
